(19) United States
(12) Patent Application Publication
(10) Pub. No.: US 2026/0235344 A1
(43) Pub. Date: Aug. 13, 2026

(54) DOOR DEVICE AND REFRIGERATION APPARATUS

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Tianxiang Jia, Hefei (CN); Zhanwei Liu, Hefei (CN); Yu Wang, Hefei (CN); Wenbang Zhang, Hefei (CN)

(21) Appl. No.: 19/161,234

(22) PCT Filed: Nov. 19, 2024
(86) PCT No.: PCT/CN2024/132873

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202422088732.2

(51) Int. Cl. F25D 23/02; E05D 15/58

(52) U.S. Cl. CPC F25D 23/021; E05D 15/58; E05D 2015/585; E05Y 2201/722; E05Y 2900/31; F25D 2323/024

(57) ABSTRACT

Disclosed are a door device and a refrigeration apparatus. The door device includes a cupboard door rotatably connected to a cupboard, an enclosure door slidably mounted on the outer side of the cupboard door, and a door sliding mechanism comprising a traction assembly and a door sliding assembly. The traction assembly drives the door sliding assembly during opening and closing of the cupboard door, causing the enclosure door to move in the width direction of the cupboard door. This configuration allows the enclosure door to slide relative to the cupboard door as the cupboard door rotates, thereby avoiding interference with surrounding kitchen furniture while maintaining coordinated appearance and user convenience when the refrigeration apparatus is embedded.

### CROSS-REFERENCES TO RELATED APPLICATIONS

The present application claims priority to Chinese patent application No. 202323218961.3, filed on Nov. 27, 2023, entitled “a Refrigerator Hinge”, Chinese patent application No. 202410088590.1, filed on Jan. 22, 2024, entitled “Door Body Assembly and Refrigeration Apparatus”, and Chinese patent application No. 202422088732.2, filed on Aug. 26, 2024, entitled “Door Body Device and Refrigeration Apparatus”, all of which are incorporated herein by reference.

### FIELD

The present application relates to the technical field of refrigeration apparatus, and in particular to a door body device and refrigeration apparatus.

### BACKGROUND

Currently, refrigerators are essential appliances for almost every household. Most existing refrigerators are cupboard-type. Whether in the kitchen or living room, the placement of refrigerators requires a certain amount of space. In order to save space, some existing refrigerators are placed together with cupboards in an embedded manner.

To further enhance coordination and aesthetics, some embedded refrigerators are decorated with decorative panels at the outside of the refrigerator door, and the decorative panels are made to be flush with the cupboard on the side of the refrigerators. However, in practice, the gap between the refrigerator and the cupboard is small, and when the refrigerator door is opened, the decorative panel may interfere with the cupboard, negatively impacting user experience.

### SUMMARY

The present application provides a door body device for avoiding the problem of interference between the decorative panel and the cupboard during the opening of the refrigerator door while ensuring coordination and aesthetics and not affecting user experience.

The present application also provides a refrigeration apparatus.

In an embodiment, a door body device includes:
a box door, rotatably connected to a box body, and configured to open or close a storage space of the box body;
a cupboard door, the cupboard door being slidably provided at an outside of the box door, the cupboard door having a thickness of 12 to 26 mm; and
a slide door mechanism, including a traction assembly and a slide door assembly connected to each other, the traction assembly being at least provided at a bottom wall of the box body, the slide door assembly being provided at the box door and connected to the cupboard door, the traction assembly being configured to drive, during opening or closing of the box door, the slide door assembly to operate, to drive the cupboard door to move relative to a width direction of the box door.

In an embodiment, the door body device is installed after the box body of the refrigeration apparatus. During the rotation of the box door relative to the box body, the slide door assembly can move the cupboard door relative to the box door under the drive of the traction assembly. Therefore, when the refrigeration apparatus is placed in the cupboard in an embedded manner, the cupboard door can be prevented from interfering with the cupboard during the opening of the box door, while ensuring coordination and aesthetics and not affecting user experience.

In an embodiment, the box door is rotatably connected to the box body through a first hinge provided at a lower cross beam of the box body, and the traction assembly is provided close to the first hinge.

In an embodiment, the first hinge includes a first hinge plate and a first hinge shaft, the first hinge plate includes a support plate and an extension plate, the support plate is installed on the lower cross beam of the box body, the extension plate is connected to a side of the support plate facing away from a front surface of the box body, the support plate and the extension plate are provided at an angle, the first hinge shaft is provided at a top surface of the extension plate and extends upward, and a bottom of corresponding box door is hinged to the first hinge shaft; where, the traction assembly is provided close to the first hinge plate.

In an embodiment, the traction assembly is provided within an installation area, the installation area is located at the bottom wall of the box body, the installation area includes a first side, a second side, a third side, and a fourth side, the first side and the third side are provided opposite each other, the second side and the fourth side are provided opposite each other, the first side is located within a plane where a side surface of the box body lies, the second side is located within a plane where a front surface of the box body lies, in a width direction of the box body, a first distance is formed between the third side and the first side; and in a thickness direction of the box body, a second distance is formed between the fourth side and the second side.

In an embodiment, the first distance is greater than zero and less than or equal to 100 mm, and the second distance is greater than zero and less than or equal to 60 mm.

In an embodiment, a number of the box doors is two, the two box doors are provided side by side, each of the two box doors is provided with a corresponding cupboard door and slide door mechanism, and at least one of two traction assemblies is provided at the bottom wall of the box body.

In an embodiment, the traction assembly includes a traction rod, a first rotary shaft fixation base and a second rotary shaft fixation base;
the first rotary shaft fixation base is connected to the slide door assembly, the second rotary shaft fixation base is connected to the bottom wall of the box body, one end of the traction rod is rotatably connected to the first rotary shaft fixation base, and other end of the traction rod is rotatably connected to the second rotary shaft fixation base; and
during the opening or closing of the box door, the traction rod drives the slide door assembly to operate, to drive the cupboard door to move relative to the width direction of the box door.

In an embodiment, the slide door assembly includes:
a pedestal, having a first guide rail formed at one side and a second guide rail formed at other side;
a first slider, slidably provided at the first guide rail, and the traction assembly being connected to the first slider;
a second slider, slidably provided at the second guide rail, and connected to the cupboard door;
a transmission member, two ends of the transmission member being respectively connected to the first slider and the second slider in a transmission manner; and
during the opening or closing of the box door, the traction assembly drives the first slider to move at the first guide rail, and the first slider drives, via the transmission member, the second slider to move at the second guide rail in an opposite direction.

In an embodiment, the transmission member includes:
a first gear rack, provided at the first slider;
a second gear rack, provided at the second slider; and
a gear, rotatably provided at the pedestal, and meshing with the first gear rack and the second gear rack.

In an embodiment, a refrigeration apparatus includes:
a box body, formed with a storage space; and
the door body device described above, the box door being rotatably connected to the box body and configured to open or close the storage space of the box body.

In addition to the technical problems solved by the application, the technical features of the solutions constituted, and the advantages brought about by the solutions with these technical features described above, other technical features of the application and the advantages brought about by these technical features will be further explained in conjunction with the accompanying drawings.

### BRIEF DESCRIPTION OF THE DRAWINGS

To more clearly illustrate the solutions in the embodiments of the present application or related art the drawings required for use in the description of the embodiments or related art are briefly introduced as below. Obviously, the drawings described below are only some embodiments of the present application. For those skilled in the art, other drawings can be obtained based on these drawings without paying any creative work.

FIG. 1 is a schematic structural diagram of a refrigeration apparatus provided with a door body device according to an embodiment of the present application when sliding.

FIG. 2 is a schematic structural diagram of a refrigeration apparatus provided with a door body device according to an embodiment of the present application.

FIG. 3 is one of the partially enlarged schematic views of FIG. 2.

FIG. 4 is a schematic structural diagram of a first hinge in a door body device according to an embodiment of the present application.

FIG. 5 is a schematic structural diagram of a second hinge in a door body device according to one embodiment of the present application.

FIG. 6 is a schematic structural diagram of a third hinge in a door body device according to an embodiment of the present application.

FIG. 7 is a schematic structural diagram of a slide door mechanism in a door body device according to an embodiment of the present application.

FIG. 8 is a schematic structural diagram of the slide door mechanism shown in FIG. 7 from another perspective.

FIG. 9 is a schematic structural diagram of a slide door mechanism in a door body device according to another embodiment of the present application.

FIG. 10 is a schematic structural diagram of the slide door mechanism shown in FIG. 9 from another perspective.

### REFERENCE NUMERALS

100, box door; 110, first box door; 120, second box door; 200, cupboard door; 300, slide door mechanism; 310, traction assembly; 311, traction rod; 312, first rotary shaft fixation base; 313, second rotary shaft fixation base; 320, slide door assembly; 321, pedestal; 322, first slider; 323, second slider; 324, connection member; 3241, first connection member; 3242, second connection member; 325, join plate; 326, first reception plate; 327, second reception plate; 328, transmission member; 3281, first gear rack; 3282, second gear rack; 3283, gear; 400, hinge; 410, first hinge; 411, first hinge plate; 4111, support plate; 4112, extension plate; 412, first hinge shaft; 420, second hinge; 421, second hinge plate; 4211, mounting plate; 4212, connection plate; 422, second hinge shaft; 423, third hinge shaft; 430, third hinge; 431, third hinge plate; 432, fourth hinge shaft; 500, box body; 501, bottom wall; 510, first cupboard body; 520, second cupboard body; A, installation area.

### DETAILED DESCRIPTION

The implementations of the present application are described below in further detail with reference to the accompanying drawings and embodiments. The following embodiments are used to illustrate the present application but are not intended to limit the scope of the present application.

In the description of the embodiments of the present application, it should be noted that the terms “center”, “longitudinal”, “lateral”, “up”, “down”, “front”, “back”, “left”, “right”, “vertical”, “horizontal”, “top”, “bottom”, “inside”, “outside” and the like indicate orientations or positional relationships based on the orientations or positional relationships shown in the accompanying drawings, and are only for the convenience of describing the embodiments of the present application and simplifying the description, rather than indicating or implying that the device or element referred to must have a specific orientation, be constructed and operated in a specific orientation, and therefore cannot be understood as limiting the embodiments of the present application. In addition, the terms “first”, “second”, and “third” are used for illustrative purposes only and cannot be understood as indicating or implying relative importance. In addition, in the description of the present application, unless otherwise specified, “multiple”, “multiple pieces”, and “multiple groups” mean two or more.

In the description of the embodiments of the application, it should be noted that, unless otherwise specified or limited, the terms “connected” and “connecting” should be understood in a broad sense. For example, they can refer to fixed connection, detachable connection, or integral connection; they can refer to mechanical connection or electrical connection; they can refer to direct connection, or indirect connection through an intermediate medium. Those skilled in the art will understand the specific meanings of the above terms in the embodiments of the application based on the specific circumstances.

In the embodiments of the present application, unless otherwise expressly specified or limited, a first feature being “above” or “below” a second feature may mean that the first feature and the second feature are in direct contact, or that the first feature and the second feature are in indirect contact through an intermediate medium. Furthermore, a first feature being “above”, “up”, or “on” a second feature may mean that the first feature is directly above or obliquely above the second feature, or simply means that the first feature is higher in level than the second feature. A first feature being “below”, “down”, or “under” a second feature may mean that the first feature is directly below or obliquely below the second feature, or simply means that the first feature is lower in level than the second feature.

In the description of the specification, the description with reference to the terms “one embodiment”, “some embodiments”, “example”, “specific example”, or “some examples” means that the specific features, structures, materials or characteristics described in conjunction with the embodiments or examples are included in at least one embodiment or example of the embodiments of the present application. In the specification, the schematic representations of the above terms do not necessarily refer to the same embodiment or example. Moreover, the specific features, structures, materials or characteristics described can be combined in any one or more embodiments or examples in a suitable manner. In addition, those skilled in the art can combine and join different embodiments or examples described in the specification and the features of different embodiments or examples, unless they are contradictory.

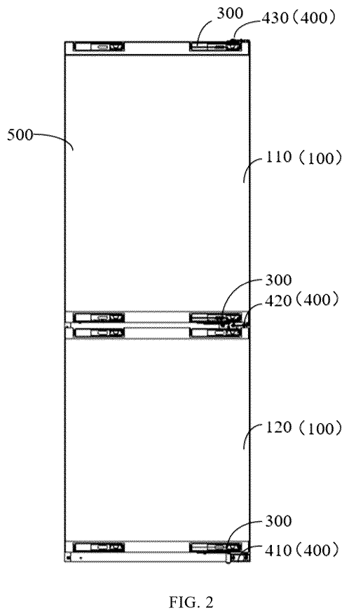

In an embodiment, as shown in FIG. 2, a door body device includes: a box door 100, a cupboard door 200, and a slide door mechanism 300. Where the box door 100 is rotatably connected to a box body 500 and is configured to open or close a storage space of the box body 500. The cupboard door 200 is slidably provided at an outside of the box door 100. The slide door mechanism 300 includes a traction assembly 310 and a slide door assembly 320, which are connected to each other. The traction assembly 310 is at least provided at a bottom wall 501 of the box body 500, and the slide door assembly 320 is provided at the box door 100 and connected to the cupboard door 200. The traction assembly 310 is configured to drive, during the opening or closing of the box door 100, the slide door assembly 320 to operate, driving the cupboard door 200 to move relative to a width direction of the box door 100.

The box door 100 has a thickness of 18-60 mm, and for example, the thickness of the box door 100 is 18 mm, 25 mm, 50 mm, 60 mm, etc. The cupboard door 200 has a thickness of 12 to 26 mm, and for example, the thickness of the cupboard door 200 is 12 mm, 18 mm, 24 mm, 26 mm, etc. In addition, the cupboard door 200 can be a wooden door or a plastic door.

It can be understood that the door body device in this embodiment can be used in a refrigeration apparatus such as a refrigerator, freezer, and ice maker, where the refrigeration apparatus includes the box body 500, which forms a storage space. The storage space can be used to place items such as vegetables and fruits that need to be refrigerated or frozen. In an embodiment, the box body 500 of the refrigeration apparatus is further provided with a refrigeration device, etc., which can cool the storage space.

In an embodiment, the box door 100 in the door body device is rotatably provided at the box body 500 of the refrigeration apparatus through a hinge 400. The box door 100 can be used to open or close the storage space in the box body 500. When the box door 100 is at a closed position closing the storage space, the storage space is at a closed state, and the items in the storage space can be refrigerated. When the box door 100 is at an open position opening the storage space, the storage space is at an open state, and users can take out the items in the storage space.

In order to facilitate the expression of the positional relationship between various parts, in an embodiment, as shown in FIG. 2, the box body 500 is generally constructed as a rectangular structure with a certain height. The box body 500 can be placed on a horizontal plane. The box body 500 has a height direction, a width direction and a thickness direction that are perpendicular to each other, where the height direction of the box body 500 is parallel to a vertical direction, and the width direction and the thickness direction are located in the horizontal plane and perpendicular to each other.

The storage space is provided inside the box body 500, and an opening is provided at a side of the box body 500 in the thickness direction and connected to the storage space. The box door 100 is connected to the side of the box body 500 in the thickness direction at which the opening is provided. The box door 100 is provided as extending in the width direction of the box body 500. The box door 100 is connected to the hinge 400 at one side of the box body 500 in the width direction. The box door 100 can be rotatably connected to the box body 500 via the hinge 400, ensuring that the box door 100 can open or close the storage space of the box body 500.

Moreover, the side of the box body 500 at which the box door 100 is installed is the front surface, that is, the box door 100 is installed at the front surface of the box body 500.

The box door 100 is generally constructed as a flat plate structure having a certain thickness. The box door 100 has a height direction, a width direction, and a thickness direction that are perpendicular to each other, where the height direction of the box door 100 is parallel to a vertical direction, and the width direction and the thickness direction are located in a horizontal plane and perpendicular to each other. The side of the box door 100 in the width direction can be rotatably connected to the box body 500 via the hinge 400. For example, as shown in FIG. 2, the box door 100 is connected to the hinge 400 on the right side of the box body 500 in the width direction, and the box door 100 can be rotatably connected to the box body 500 via the hinge 400.

Moreover, when the box door 100 is at a position closing the storage space of the box body 500, the width direction of the box door 100 is parallel to the width direction of the box body 500, and the thickness direction of the box door 100 is parallel to the thickness direction of the box body 500.

Furthermore, the cupboard door 200 can be a decorative door panel. The cupboard door 200 is constructed as a flat plate structure having a certain thickness. The cupboard door 200 is connected to the outside of the box door 100 facing away from the box body 500. In case that the refrigeration apparatus is placed together with the cupboard in an embedded manner or directly in the cupboard, when the box door 100 is at the closed position, the cupboard door 200 can be flush with the door panel of the cupboard, that is, the outer wall surface of the cupboard door 200 facing away from the box door 100 can be flush with the outer wall surface of the cupboard.

In actual usage scenarios, the outer wall surface of the cupboard door 200 can be formed by selecting the same material and shape as the outer wall surface of the cupboard, and attaching with the same decoration thereon, so that the refrigeration apparatus can be sufficiently coordinated with the cupboard and can ensure aesthetics.

After the door body device is installed on the box body 500 of the refrigeration apparatus in this embodiment, when the box door 100 rotates relative to the box body 500 to open or close the storage space of the box body 500, the slide door mechanism 300 can drive the cupboard door 200 to move relative to the box door 100 in the width direction of the box door 100. Therefore, when the refrigeration apparatus is placed in the cupboard in an embedded manner, the cupboard door 200 can be prevented from interfering with the cupboard during the opening of the box door 100, while ensuring coordination and aesthetics and not affecting user experience.

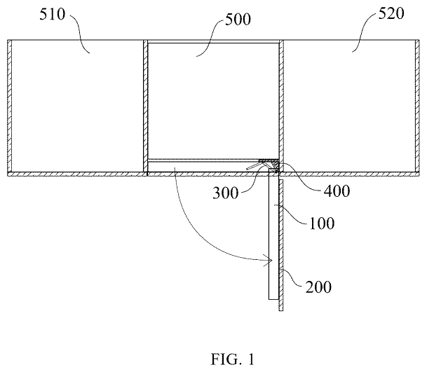

In an embodiment, as shown in FIG. 1, the door body device and the box body 500 are configured to be provided in an installation space formed between a first cupboard body 510 and a second cupboard body 520. During the opening or closing of the box door 100, the slide door mechanism 300 is configured to drive the cupboard door 200 to move a preset distance on the box door 100, so that the cupboard door 200 avoids the side walls of the first cupboard body 510 and the second cupboard body 520.

In an embodiment, the door body device and the box body 500 are configured to be provided in the cupboard body. During the opening or closing of the box door 100, the slide door mechanism 300 is configured to drive the cupboard door 200 to move a preset distance on the box door 100, so that the cupboard door 200 avoids the side wall of the cupboard body.

It can be understood that the refrigeration apparatus includes the door body device and the box body 500.

In practice, as shown in FIG. 1, when a refrigeration apparatus having the door body device and the box body 500 is placed between the first cupboard body 510 and the second cupboard body 520 adjacent to each other, the cupboard door 200 may be provided at the outside of the box door 100 of the door body device, and the cupboard door 200 may be movable relative to the box door 100 in the width direction of the box door 100. In an embodiment, when the box door 100 is in a state of closing the storage space of the box body 500, the outer wall surface of the cupboard door 200 facing away from the box door 100 may be flush with the outer wall surfaces of the first cupboard body 510 and the second cupboard body 520, and the outer wall surfaces of the first cupboard body 510 and the second cupboard body 520 and the outer wall surface of the cupboard door 200 facing away from the box door 100 are in the same direction in the thickness direction of the box body 500.

In this case, during the rotation of the box door 100 relative to the box body 500, the slide door mechanism 300 can drive the cupboard door 200 to move, so that the cupboard door 200 avoids the side walls of the first cupboard body 510 and the second cupboard body 520.

In an embodiment, after the refrigeration apparatus is placed in the cupboard body, the cupboard door 200 can be provided at the outside of the box door 100 of the door body device, and the cupboard door 200 can be movable relative to the box door 100. In an embodiment, when the box door 100 is in a state of closing the storage space of the box body 500, the outer wall surface of the cupboard door 200 facing away from the box door 100 can be flush with the outer wall surface of the cupboard body, and the outer wall surface of the cupboard body and the outer wall surface of the cupboard door 200 facing away from the box door 100 are in the same direction in the thickness direction of the box body 500.

In this case, during the rotation of the box door 100 relative to the box body 500, the slide door mechanism 300 can drive the cupboard door 200 to move, and can also allow the cupboard door 200 to avoid the side wall of the cupboard body.

Furthermore, in an embodiment, the number of the box doors 100 is multiple, each box door 100 corresponds to at least one storage space, and each box door 100 is rotatably connected to the box body 500 through multiple hinges 400. Where the box door 100 at the bottom is rotatably connected to the box body 500 through a first hinge 410 provided at a lower cross beam of the box body 500, and the traction assembly 310 corresponding to the box door 100 at the bottom of the box body 500 is provided close to the first hinge 410.

It can be understood that, according to different refrigeration needs, the box bodies 500 of different refrigeration apparatus can be provided with different numbers of storage spaces. These storage spaces are spaced apart in the height direction of the box body 500. Some storage spaces are used for refrigeration, and some storage spaces are used for freezing. Accordingly, in order to be able to close these storage spaces in a targeted manner, the number of box doors 100 can be multiple, and each box door 100 at least corresponds to the position of one of the storage spaces.

For example, as shown in FIG. 2, the box body 500 is provided with two storage spaces spaced apart in the vertical direction. The two storage spaces can be used for refrigeration and freezing, respectively. The number of the box doors 100 is two, the two box doors 100 are a first box door 110 and a second box door 120. The two box doors 100 correspond to the positions of the two storage spaces. In this case, the two storage spaces can be opened or closed independently through the two box doors 100.

For another example, the box body 500 may be provided with three storage spaces spaced apart in the vertical direction, namely a first space, a second space, and a third space. The first space and the second space are used for refrigeration, and the third space is used for freezing. The number of the box doors 100 is two, and the two box doors 100 are a first box door 110 and a second box door 120. The first box door 110 corresponds to the positions of the first and second spaces, and the second box door 120 corresponds to the position of the third space. In this case, the first box door 110 can be used to open or close the first and second spaces simultaneously, and the second box door 120 can be used to control the opening and closing of the third space separately.

It can be understood that in this embodiment, each box door 100 can correspond to a separate storage space. In this case, the box door 100 can independently control the opening and closing status of the storage space. In actual use, according to needs, each box door 100 can also correspond to multiple adjacent storage spaces. In this case, the box door 100 can simultaneously control the opening and closing status of the multiple storage spaces.

In an embodiment, as shown in FIG. 2, the door body device includes a first box door 110 and a second box door 120, and the first box door 110 and the second box door 120 are spaced apart in the height direction of the box body 500. In this case, the bottom of the second box door 120 can be rotatably connected to the box body 500 by means of a first hinge 410 provided at a lower cross beam of the box body 500, and the top of the first box door 110 can be rotatably connected to the box body 500 by means of a third hinge 430 provided at the top wall of the box body 500.

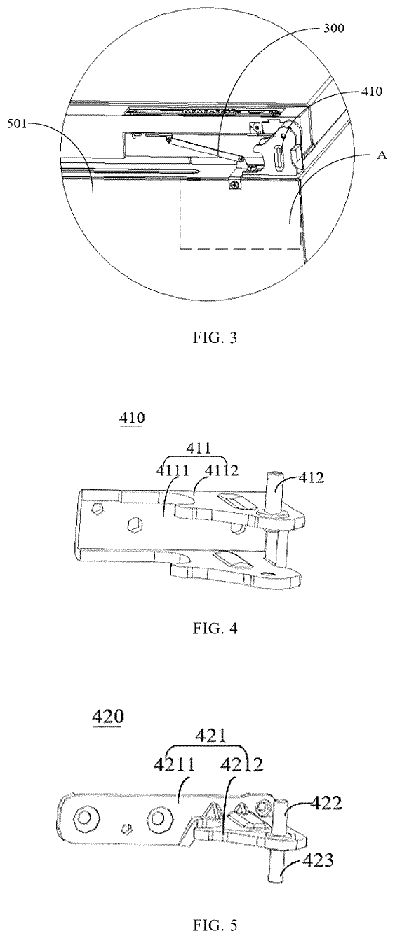

Correspondingly, as shown in FIG. 3, the traction assembly 310 at the bottom wall 501 of the box body 500 is provided close to the first hinge 410. Under the action of the traction assembly 310, the slide door assembly 320 can drive the cupboard door 200 corresponding to the second box door 120 to move relative to the width direction of the second box door 120.

Furthermore, in order to effectively realize the installation of the box door 100, the hinge 400 can also include a second hinge 420, where the second hinge 420 is provided at the front surface (middle cross beam) of the box body 500, and the second hinge 420 is located between the first hinge 410 and the third hinge 430.

For example, since multiple box doors 100 are spaced apart in the height direction of the box body 500, the second hinge 420 can be provided between two adjacent box doors 100, and at least one of the two adjacent box doors 100 can be rotatably connected to the box body 500 by means of the second hinge 420.

In practical applications, the number of the second hinges 420 can be one or two. For example, when the number of the second hinge 420 is one, one of two adjacent box doors 100 can be connected to the one second hinge 420 and rotatably connected to the box body 500 by means of the one second hinge 420. In an embodiment, the two adjacent box doors 100 can be both connected to the one second hinge 420 and rotatably connected to the box body 500 by means of the one second hinge 420.

For example, as shown in FIG. 2, the box door 100 includes a first box door 110 and a second box door 120. In this case, the second hinge 420 can be provided between the first box door 110 and the second box door 120, and the bottom of the first box door 110 and the top of the second box door 120 can be both hinged to the second hinge 420, so as to be rotatably connected to the box body 500.

In another embodiment, when the number of the second hinges 420 is two, the two second hinges 420 can be spaced apart in the height direction of the box body 500. In this case, the two adjacent box doors 100 can be hinged to the two second hinges 420 respectively, and then rotatably connected to the box body 500 by mean of their respective second hinges 420.

Furthermore, in an embodiment, as shown in FIG. 4, the first hinge 410 includes a first hinge plate 411 and a first hinge shaft 412. The first hinge plate 411 includes a support plate 4111 and an extension plate 4112, the support plate 4111 is installed on the front surface (lower cross beam) of the box body 500, the extension plate 4112 is connected to the side of the support plate 4111 facing away from the front surface of the box body 500. The support plate 4111 and the extension plate 4112 are provided at an angle. The first hinge shaft 412 is provided at the top surface of the extension plate 4112 and extends upward, and the bottom of the second box door 120 is hinged to the first hinge shaft 412.

Similarly, the first hinge plate 411 and the first hinge shaft 412 can also be made of a metal or non-metallic material with a certain structural strength. The first hinge plate 411 includes a support plate 4111 and an extension plate 4112 that are connected to each other. The extension plate 4112 is generally perpendicular to the support plate 4111, and the two can be integrally formed by stamping or other means. The support plate 4111 is provided with multiple mounting holes, and the first hinge shaft 412 is fixed to the extension plate 4112 by welding or threaded connection.

During actual installation, multiple threaded holes can be provided in advance at a location at the front surface of the box body 500 and near the bottom, and then one side of the support plate 4111 in the thickness direction is fitted to the front surface of the box body 500, and then the mounting holes on the support plate 4111 are made to correspond to the positions of the threaded holes, and then the support plate 4111 is fixed to the front surface of the box body 500 by means of bolts. The extension plate 4112 is connected to the other side of the support plate 4111 in the thickness direction and extends toward the direction in which the box door 100 is located, and the first hinge shaft 412 extends upward in the height direction of the box body 500.

Based on this, when installing the box door 100, hinge holes can be provided in advance at the bottom of the box door 100 corresponding to the first hinge 410, and then the first hinge shaft 412 is inserted into the hinge holes, thereby realizing the installation of the box door 100.

Thus, the traction assembly 310 located on the bottom wall 501 of the box body 500 is provided close to the first hinge plate 411. Furthermore, as shown in FIG. 3, the traction assembly 310 is provided within an installation area A, which is located at the bottom wall 501 of the box body 500. The installation area A includes a first side, a second side, a third side, and a fourth side. The first side and the third side are provided opposite each other, and the second side and the fourth side are provided opposite each other. The first side is located within a plane where the side surface of the box body 500 lies, and the second side is located within a plane where the front surface of the box body 500 lies. In the width direction of the box body 500, a first distance is formed between the third side and the first side. In the thickness direction of the box body 500, a second distance is formed between the fourth side and the second side.

In an embodiment, the first distance is greater than zero and less than or equal to 100 mm, and the second distance is greater than zero and less than or equal to 60 mm. For example, the first distance is 20 mm, 50 mm, 60 mm, 80 mm, or 100 mm, and the second distance is 20 mm, 40 mm, 50 mm, or 60 mm.

Further, in an embodiment, as shown in FIG. 5, the second hinge 420 includes a second hinge plate 421, a second hinge shaft 422 and a third hinge shaft 423. The second hinge plate 421 includes a mounting plate 4211 and a connection plate 4212. The mounting plate 4211 is installed on the front surface (middle cross beam) of the box body 500, the connection plate 4212 is connected to a side of the mounting plate 4211 facing away from the front surface of the box body 500, the connection plate 4212 and the mounting plate 4211 are provided at an angle. The connection plate 4212 has a first side and a second side opposite each other, the second hinge shaft 422 is provided at the first side, the bottom of the first box door 110 is hinged to the second hinge shaft 422, and the third hinge shaft 423 is provided at the second side. The top of the second box door 120 is hinged to the third hinge shaft 423, and the second hinge 420 can be provided with at least one traction assembly 310. In the case where the number of the traction assemblies 310 is two, one traction assembly 310 corresponds to the first box door 110, and the other traction assembly 310 corresponds to the second box door 120.

For example, the second hinge plate 421 can be made of a metal or non-metallic material with a certain structural strength. The second hinge plate 421 includes a mounting plate 4211 and a connection plate 4212 that are connected to each other. The connection plate 4212 is generally perpendicular to the mounting plate 4211 and the mounting plate 4211 is provided with multiple mounting holes. During actual manufacturing, the mounting plate 4211 and the connection plate 4212 can be integrally formed from a same plate, and then the connection plate 4212 can be bent relative to the mounting plate 4211 by stamping and folding.

Two sides of the connection plate 4212 in the thickness direction are respectively a first side and a second side. The first side is fixedly connected to the second hinge shaft 422, and the second side is fixedly connected to the third hinge shaft 423.

During actual manufacturing, the second hinge shaft 422 and the third hinge shaft 423 can be fixedly connected to the connection plate 4212 by welding. In an embodiment, the second hinge shaft 422 and the third hinge shaft 423 can be constructed as a long, rod-shaped integral piece, the connection plate 4212 is provided with through holes penetrating in the thickness direction thereof, and the integral piece is inserted into the through holes. The integral piece is fixed into the through holes by welding or threading connection, and the second hinge shaft 422 and the third hinge shaft 423 are respectively formed at two ends of the integral piece in the length direction of the connection plate 4212.

During actual installation, multiple threaded holes can be provided in advance at the front surface of the box body 500 according to the installation position of the box door 100. For example, as shown in FIG. 2, multiple threaded holes are provided at a location at the front surface of the box body 500 and corresponding to a gap position between the first box door 110 and the second box door 120. Then, the mounting holes on the mounting plate 4211 of the second hinge plate 421 are made to correspond to the positions of the threaded holes, and then the mounting plate 4211 is fixed to the front surface of the box body 500 by means bolts. In this case, the connection plate 4212 extends toward the direction of the box door 100. Meanwhile, the second hinge shaft 422 extends upward in the height direction of the box body 500, and the third hinge shaft 423 extends downward in the height direction of the box body 500.

Based on this, when installing the box door 100, hinge holes can be provided in advance at the bottom of the box door 100 corresponding to the second hinge shaft 422, and hinge holes can be provided in advance at the top of the box door 100 corresponding to the third hinge shaft 423. Then, the second hinge shaft 422 and the third hinge shaft 423 can be respectively inserted into the corresponding hinge holes of the box door 100, thereby realizing the installation of the box door 100.

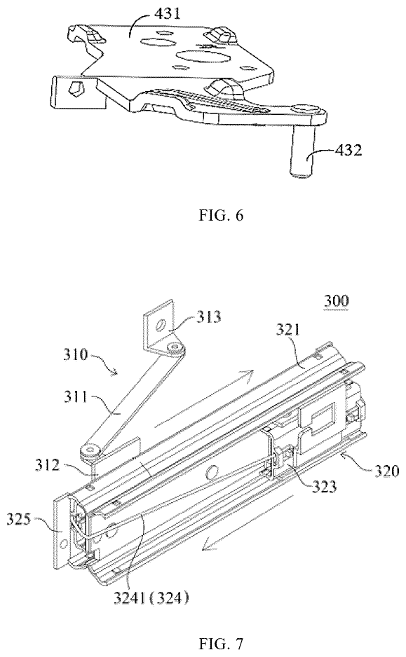

Furthermore, in an embodiment, as shown in FIG. 6, the third hinge 430 includes a third hinge plate 431 and a fourth hinge shaft 432. A portion of the third hinge plate 431 covers the top wall of the box body 500, and the remaining portion protrudes from the top wall toward the corresponding box door 100. The fourth hinge shaft 432 extends downward from the portion of the third hinge plate 431 that protrudes from the top wall. The top of the first box door 110 is hinged to the fourth hinge shaft 432. Where the third hinge 430 may be provided with a traction assembly 310 corresponding to the first box door 110.

For example, the third hinge plate 431 and the fourth hinge shaft 432 can be made of a metal or non-metallic material with a certain structural strength. The third hinge plate 431 includes a first fitting portion and a first protruding portion that are connected to each other. The first fitting portion is provided with multiple mounting holes. The fourth hinge shaft 432 is fixed to the first protruding portion by welding or threaded connection.

During actual installation, multiple threaded holes can be provided in advance at the top wall of the box body 500, and then the first fitting portion of the third hinge plate 431 is fitted to the top wall of the box body 500, and the mounting holes on the first fitting portion are made to correspond to the positions of the threaded holes, and then the first fitting portion is fixed to the top wall of the box body 500 by means of bolts. In this case, the first fitting portion can cover and fit to the top wall of the box body 500, the first protruding portion can protrude from the top wall toward the box door 100, and the fourth hinge shaft 432 can extend downward in the height direction of the box body 500.

Based on this, when installing the box door 100, hinge holes can be provided in advance at the top of the box door 100 corresponding to the fourth hinge 400, and then the fourth hinge shaft 432 is inserted into the hinge holes, thereby realizing the installation of the box door 100.

In another embodiment, the number of the box doors 100 is two, and the two box doors 100 are provided side by side. Each box door 100 is provided with a corresponding cupboard door 200 and a slide door mechanism 300, and at least one of the two traction assemblies 310 is provided at the top wall of the box body 500.

It should be noted that each box door 100 can be provided with one or two slide door mechanisms 300. In case that the box door 100 is provided with one slide door mechanism 300, the corresponding traction assembly 310 is provided at the bottom wall 501 of the box body 500. In case that the box door 100 is provided with two slide door mechanisms 300, one corresponding traction assembly 310 is provided at the bottom wall 501 of the box body 500, and the other traction assembly 310 can be provided at the bottom wall 501, side, lower cross beam, etc. of the box body 500.

In an embodiment, to ensure that the traction assembly 310 can drive the slide door assembly 320 to move, the traction assembly 310 includes a traction rod 311, a first rotary shaft fixation base 312, and a second rotary shaft fixation base 313. The first rotary shaft fixation base 312 is connected to the slide door assembly 320, and the second rotary shaft fixation base 313 is connected to the bottom wall 501 of the box body 500. One end of the traction rod 311 is rotatably connected to the first rotary shaft fixation base 312, and the other end of the traction rod 311 is rotatably connected to the second rotary shaft fixation base 313. During the opening or closing of the box door 100, the traction rod 311 drives the slide door assembly 320 to operate, driving the cupboard door 200 to move relative to the width direction of the box door 100. Where the second rotary shaft fixation base 313 is located within the installation area A.

For example, the hinge 400 may include a hinge plate and a hinge shaft, and the hinge shaft is fixed to the hinge plate by welding or other means. During actual installation, the hinge plate may be fixed to the box body 500 by means of bolts or other structures. The box door 100 may be provided in advance with threaded holes. After the hinge plate is fixed to the box body 500, the hinge shaft can be allowed to be inserted into the hinge holes of the box door 100, thereby realizing a rotational connection of the box door 100 relative to the box body 500.

In the traction assembly 310, the first rotary shaft fixation base 312 is provided at the slide door assembly 320, and the second rotary shaft fixation base 313 is provided at the bottom wall 501 and close to the hinge plate. Two ends of the traction rod 311 are rotatably connected to the first rotary shaft fixation base 312 and the second rotary shaft fixation base 313, respectively.

In actual use, when the box door 100 rotates relative to the box body 500 between the positions of opening or closing the storage space, the traction assembly 310 can pull the slide door assembly 320 to operate, so that the slide door assembly 320 drives the cupboard door 200 to move relative to the box door 100 in the width direction of the box door 100.

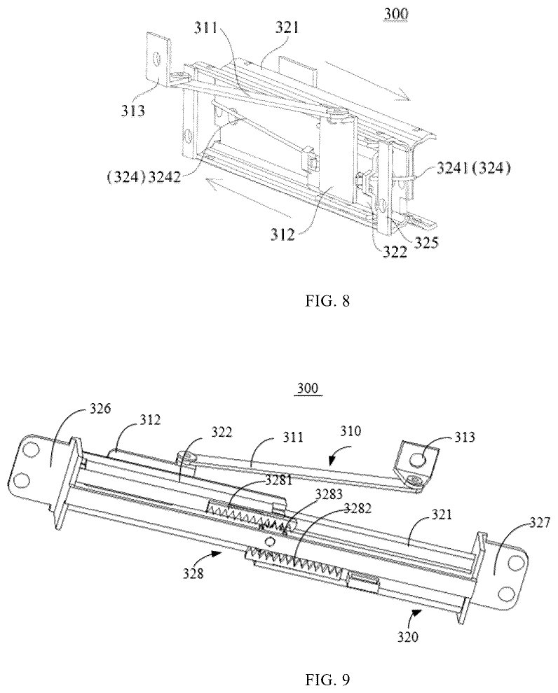

Furthermore, in an embodiment, in order to enable the slide door assembly 320, under the drive of the traction assembly 310, to effectively drive the cupboard door 200 to move relative to the box door 100, as shown in FIGS. 7 and 8, the slide door assembly 320 includes a pedestal 321, a first slider 322, a second slider 323, and a connection member 324.

In an embodiment, a first guide rail is formed at one side of the pedestal 321, and a second guide rail is formed at the other side of the pedestal 321. The first slider 322 is slidably provided at the first guide rail, and the first rotary shaft fixation base 312 is connected to the first slider 322. The second slider 323 is slidably provided at the second guide rail and is connected to the cupboard door 200. Two ends of the connection member 324 are respectively connected to the first slider 322 and the second slider 323.

During the opening or closing of the box door 100, the traction rod 311 drives the first slider 322 to move at the first guide rail, and the first slider 322 drives, via the connection member 324, the second slider 323 to move at the second guide rail in an opposite direction.

For example, the pedestal 321 has a first guide rail and a second guide rail, which are provided side by side and spaced apart. The first slider 322 is provided at the first guide rail and the first slider 322 can slide in the length direction of the first guide rail. The second slider 323 is provided at the second guide rail and the second slider 323 can slide in the length direction of the second guide rail. Furthermore, the first slider 322 and the second slider 323 are connected by the connection member 324. When the first slider 322 moves at the first guide rail, the connection member 324 can pull the second slider 323 to move at the second guide rail, and the second slider 323 moves in the opposite direction to that of the first slider 322.

In an embodiment, as shown in FIGS. 7 and 8, the pedestal 321 has a first side and a second side on opposite sides in the thickness direction, respectively. U-shaped grooves are formed at the first side and the second side, respectively. The U-shaped groove on the first side is formed as the first guide rail, and the U-shaped groove on the second side is formed as the second guide rail. The first guide rail and the second guide rail are provided as extending in the length direction of the pedestal 321. The first slider 322 is slidably provided in the first guide rail, and the second slider 323 is slidably provided in the second guide rail. Furthermore, the first rotary shaft fixation base 312 is connected to the first slider 322, and the cupboard door 200 can be fixedly connected to the second slider 323.

Taking into account the needs in actual use, limiting structures can also be provided at the ends at two sides of the first guide rail and the second guide rail. With the restriction of the limiting structures, the first slider 322 and the second slider 323 are allowed to move within a set moving range, so that the moving distance are set according to needs in order to meet the usage requirements of different occasions.

Accordingly, the traction rod 311 is constructed as a long straight rod, one end of the traction rod 311 is rotatably connected to the first rotary shaft fixation base 312 via a first rotation shaft, and the other end of the traction rod 311 is rotatably connected to the second rotary shaft fixation base 313 via a second rotation shaft.

In an embodiment, as shown in FIG. 8, the first rotary shaft fixation base 312 includes a first vertical plate and a first horizontal plate, which are connected to each other and forms an L-shaped structure. The first horizontal plate is provided with shaft holes, into which the first rotation shaft is inserted. One end of the traction rod 311 is rotatably connected to the first rotation shaft, thereby being fixedly connected to the first rotary shaft fixation base 312. The first vertical plate can be fixedly connected to the first slider 322 by welding or other means.

Similarly, as shown in FIGS. 7 and 8, the second rotary shaft fixation base 313 includes a second vertical plate and a second horizontal plate, which are connected to each other and forms an L-shaped structure. The second horizontal plate is provided with shaft holes, into which the second rotation shaft can be inserted. The other end of the traction rod 311 is rotatably connected to the second rotation shaft, thereby being rotatably connected to the second rotary shaft fixation base 313.

To ensure that the first slider 322 and the second slider 323 can move synchronously in opposite directions, for example, the connection member 324 includes a first connection member 3241 and a second connection member 3242, the first connection member 3241 and the second connection member 3242 are constructed as flexible cables. In the length direction of the pedestal 321, the first connection member 3241 bypasses one end of the pedestal 321, and two ends of the first connection member 3241 respectively enter the first guide rail and the second guide rail and are respectively connected to the first slider 322 and the second slider 323. Correspondingly, the second connection member 3242 bypasses the other end of the pedestal 321, and two ends of the second connection member 3242 also respectively enter the first guide rail and the second guide rail and are respectively connected to the first slider 322 and the second slider 323. In this case, two ends of the first connection member 3241 are connected to two ends of the second connection member 3242 via the first slider 322 and the second slider 323 respectively, forming a generally annular structure.

During actual installation, after the hinge plate is fixedly mounted to the box body 500, the second rotary shaft fixation base 313 can be fixed to the bottom wall 501 of the box body 500 by means of bolts or other structures.

Next, the pedestal 321 can be fixed to the box door 100 by means of bolts or other structures. For example, join plates 325 are respectively provided at two sides of the pedestal 321 in the length direction, and the two join plates 325 are provided with through holes respectively. During installation, external bolts can be passed through the through holes in the join plates 325 and connected to the box door 100, thereby fixing the pedestal 321 to the box door 100.

Afterwards, the cupboard door 200 is fixed to the second slider 323. For example, the cupboard door 200 can be fixedly connected to the second slider 323 by means of bolts, clamping structures, and the like.

In actual use, as shown in FIGS. 7 and 8, when the box door 100 moves relative to the box body 500 from a position closing the storage space to a position opening the storage space, the second rotary shaft fixation base 313 is fixed to the bottom wall 501 of the box body 500. During the rotation of the box door 100, the first slider 322 moves at the first guide rail in the first direction. Accordingly, the first slider 322 pulls the second slider 323 to move at the second guide rail in the second direction through the first connection member 3241. Since the pedestal 321 is fixedly connected to the box door 100 and the second slider 323 is fixedly connected to the cupboard door 200, the cupboard door 200 moves relative to the box door 100 in the second direction. Where the first direction is opposite to the second direction, and both the first direction and the second direction are parallel to the width direction of the box door 100.

Correspondingly, in case that the box door 100 moves relative to the box body 500 from a position opening the storage space to a position closing the storage space, during the rotation of the box door 100, the first slider 322 moves at the first guide rail in a direction opposite to the first direction. Accordingly, the first slider 322 pulls, via the second connection member 3242, the second slider 323 to move at the second guide rail in a direction opposite to the second direction. In this case, the cupboard door 200 moves relative to the box door 100 in the direction opposite to the second direction.

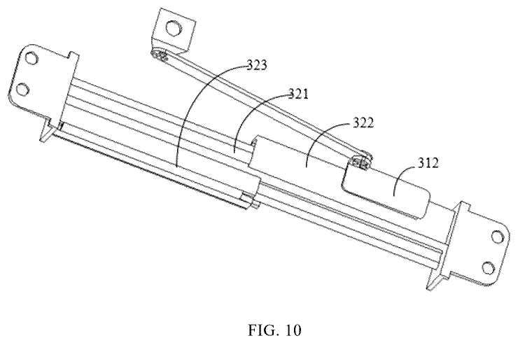

In another embodiment, as shown in FIGS. 9 and 10, a slide door mechanism 300 includes a pedestal 321, a first slider 322, a second slider 323, and a transmission member 328. A first guide rail is formed at one side of the pedestal 321, and a second guide rail is formed at the other side of the pedestal 321. The first slider 322 is slidably provided at the first guide rail, and the second slider 323 is slidably provided at the second guide rail. Two ends of the transmission member 328 are respectively connected to the first slider 322 and the second slider 323 in a transmission manner. In case that the first slider 322 moves at the first guide rail, the first slider 322 drives, via the connection member 324. the second slider 323 to move at the second guide rail in an opposite direction.

The pedestal 321 can be fixed to the box door 100 by means of bolts or other structures. For example, a first reception plate 326 and a second reception plate 327 are respectively provided at two sides of the pedestal 321 in the length direction, and the first reception plate 326 and the second reception plate 327 are provided with through holes respectively. During installation, external bolts can be passed through the through holes in the first reception plate 326 and the second reception plate 327 and connected to the box door 100, thereby fixing the pedestal 321 to the box door 100.

In some embodiments, the traction assembly includes a first connection rod and a second connection rod. The first end of the first connection rod is rotatably provided at the bottom wall 501 of the box body 500.

The first end of the first connection rod is rotatably provided within the mounting area. For example, the first end of the first connection rod is mounted within the mounting area through a rotary shaft fixation base. The first end of the second connection rod is rotatably connected to the second end of the first connection rod, the second end of the second connection rod is rotatably provided at the box door 100 and meshes with teeth on the first slider 322 through a gear provided at the second end of the second connection rod.

It can be understood that the first connection rod and the second connection rod are connected by a hinge, and the first connection rod and the second connection rod can rotate relative to each other. The first connection rod can rotate relative to the box body 500, and the second connection rod can rotate relative to the box door 100.

When the second end of the second connection rod makes a circular motion with the box door 100 with the hinge shaft as the circle center, since the first end of the first connection rod is staggered with the hinge shaft, the distance between the second end of the second connection rod and the first end of the first connection rod changes, while the position of the second end of the second connection rod relative to the box door 100 remains unchanged, the second end of the second connection rod is caused to rotate around the box door 100 and the second slider 323 is driven to drive the cupboard door 200 to move in the width direction of the box door 100.

In actual use, during the opening of the box door 100, the box door 100 drives the second end of the second connection rod to rotate relative to the hinge shaft. Based on the staggered arrangement of the first end of the first connection rod and the hinge shaft, the distance between the first end of the first connection rod and the second end of the second connection rod increases, driving the second end of the second connection rod to rotate clockwise relative to the box door 100, thereby controlling the second slider 323 to drive the cupboard door 200 to move in the width direction of the box door 100 towards the direction away from the hinge 400, that is, to move to the left relative to the box door 100, so that the interference between the cupboard door 200 and the cupboard door 200 of the cupboard body on the side can be avoided. During the closing of the box door 100, the box door 100 drives the second end of the second connection rod to rotate relative to the hinge shaft. Based on the staggered arrangement of the first end of the first connection rod and the hinge shaft, the distance between the first end of the first connection rod and the second end of the second connection rod decreases, driving the second end of the second connection rod to rotate counterclockwise relative to the box door 100, thereby controlling the second slider 323 to drive the cupboard door 200 to move in the width direction of the box door 100 towards the direction close to the hinge 400, that is, to move to the right relative to the box door 100. This ensures that when the box door 100 is closed, the cupboard door 200 can avoid the cupboard door 200 of the cupboard body on the side and reset the cupboard door 200.

In an embodiment, the first rotary shaft fixation base 312 is connected to the first slider 322, and the second slider 323 is connected to the cupboard door 200. Where the first guide rail and the second guide rail serve as a kind of track, and the first slider 322 and the second slider 323 are slide members adapted to and slidable along the corresponding guide rails. Furthermore, the sliding fit between the first slider 322 and the first guide rail should at least include a situation where balls are provided between the first slider 322 and the first guide rail, and the sliding fit between the second slider 323 and the second guide rail should at least include a situation where balls are provided between the second slider 323 and the second guide rail.

As shown in FIG. 9, the transmission member 328 includes a first gear rack 3281, a second gear rack 3282, and a gear 3283. Where the first gear rack 3281 is provided at the first slider 322, and the second gear rack 3282 is provided at the second slider 323. The gear 3283 is rotatably provided at the pedestal 321 and meshes with the first gear rack 3281 and the second gear rack 3282.

In this embodiment, when the first slider 322 slides along the first guide rail, the first gear rack 3281 slides with the first slider 322, and the first gear rack 3281 meshes with the gear 3283. When the first gear rack 3281 slides, it drives the gear 3283 to rotate, and the second gear rack 3282 and the first gear rack 3281 respectively mesh with two sides of the gear 3283. When the gear 3283 rotates, it can drive the second gear rack 3282 to slide relative to the first gear rack 3281 in an opposite direction, thereby driving the second slider 323 to slide relative to the first slider 322 in the opposite direction. The structure is simple, convenient and practical.

As shown in FIG. 9, the transmission member 328 further includes a pin, which is provided at the pedestal 321, and the gear 3283 is rotatably provided at the pin.

In this embodiment, the pin is provided at the pedestal 321 so that the gear 3283 can be provided. The gear 3283 is rotatably provided at the pin and can rotate around the pin so as to transmit power between the first gear rack 3281 and the second gear rack 3282, so that the first gear rack 3281 and the second gear rack 3282 slide in opposite directions, and the first slider 322 and the second slider 323 can slide in opposite directions.

In addition, as described above, a refrigeration apparatus is also provided in an embodiment, which includes a box body 500 and the door body device described in the above embodiments, where the box body 500 is formed with a storage space, and the box door 100 is rotatably connected to the box body 500 through a hinge 400, and configured to open or close the storage space of the box body 500.

Finally, it should be noted that the terms “parallel” and “perpendicular” in the embodiments of the application should not be strictly limited to the geometric sense, and at least manufacturing and installation errors should be considered. For example, errors of plus or minus 10° should be within the scope protected by the embodiments of the application. In addition, the above embodiments are only used to illustrate the solutions of the application, and not intended to limit them. Although the application has been described in detail with reference to the aforementioned embodiments, those skill in the art should understand that the solutions described in the aforementioned embodiments can still be modified, or some of the technical features therein can be replaced by equivalents. However, these modifications or replacements do not deviate the essence of the corresponding solutions from the spirit and scope of the solutions of the embodiments of the application.

1. A door body device, used for a refrigeration apparatus comprising a box body, comprising:
a box door, rotatably connected to the box body and configured to open or close a storage space of the box body;
a cupboard door, the cupboard door being slidably provided at an outside of the box door, the cupboard door having a thickness of 12 to 26 mm; and
a slide door mechanism, comprising a traction assembly and a slide door assembly connected to each other, the traction assembly being at least provided at a bottom wall of the box body, the slide door assembly being provided at the box door and connected to the cupboard door, the traction assembly being configured to drive, during opening or closing of the box door, the slide door assembly to operate, to drive the cupboard door to move relative to a width direction of the box door.

2. The door body device of claim 1, wherein the box door is rotatably connected to the box body through a first hinge provided at a lower cross beam of the box body, and the traction assembly is provided close to the first hinge.

3. The door body device of claim 2, wherein the first hinge comprises a first hinge plate and a first hinge shaft, the first hinge plate comprises a support plate and an extension plate, the support plate is installed on the lower cross beam of the box body, the extension plate is connected to a side of the support plate facing away from a front surface of the box body, the support plate and the extension plate are provided at an angle, the first hinge shaft is provided at a top surface of the extension plate and extends upward, and a bottom of corresponding box door is hinged to the first hinge shaft; wherein the traction assembly is provided close to the first hinge plate.

4. The door body device of claim 1, wherein the traction assembly is provided within an installation area (A), the installation area (A) is located at the bottom wall of the box body, the installation area (A) comprises a first side, a second side, a third side, and a fourth side, the first side and the third side are provided opposite each other, the second side and the fourth side are provided opposite each other, the first side is located within a plane where a side surface of the box body lies, the second side is located within a plane where a front surface of the box body lies, in a width direction of the box body, a first distance is formed between the third side and the first side, and in a thickness direction of the box body, a second distance is formed between the fourth side and the second side.

5. The door body device of claim 4, wherein the first distance is greater than zero and less than or equal to 100 mm, and the second distance is greater than zero and less than or equal to 60 mm.

6. The door body device of claim 1, wherein a number of the box doors is two, the two box doors are provided side by side, each of the two box doors is provided with a corresponding cupboard door and slide door mechanism, and at least one of two traction assemblies is provided at the bottom wall of the box body.

7. The door body device of claim 1, wherein the traction assembly comprises a traction rod, a first rotary shaft fixation base and a second rotary shaft fixation base;
the first rotary shaft fixation base is connected to the slide door assembly, the second rotary shaft fixation base is connected to the bottom wall of the box body, one end of the traction rody is rotatably connected to the first rotary shaft fixation base, and other end of the traction rod is rotatably connected to the second rotary shaft fixation base; and
during the opening or closing of the box door, the traction rod drives the slide door assembly to operate, to drive the cupboard door to move relative to the width direction of the box door.

8. The door body device of claim 1, wherein the slide door assembly comprises:
a pedestal, having a first guide rail formed at one side and a second guide rail formed at other side;
a first slider, slidably provided at the first guide rail, and the traction assembly being connected to the first slider;
a second slider, slidably provided at the second guide rail, and connected to the cupboard door;
a transmission member, two ends of the transmission member being respectively connected to the first slider-and the second slider in a transmission manner; and
during the opening or closing of the box door, the traction assembly drives the first slider to move at the first guide rail, and the first slider drives, via the transmission member, the second slider to move at the second guide rail in an opposite direction.

9. The door body device of claim 8, wherein the transmission member comprises:
a first gear rack, provided at the first slider;
a second gear rack, provided at the second slider; and
a gear, rotatably provided at the pedestal, and meshing with the first gear rack and the second gear rack.

10. A refrigeration apparatus, comprising:
a box body, formed with a storage space; and
the door body device of claim 1, the box door being rotatably connected to the box body and configured to open or close the storage space of the box body.
